(19) United States
(12) Patent Application Publication
(10) Pub. No.: US 2007/0024110 A1
(43) Pub. Date: Feb. 1, 2007

(54) Brake apparatus for a vehicle

(75) Inventor: Hiroshi Isono, Mishima-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/491,289

(22) Filed: Jul. 24, 2006

(30) Foreign Application Priority Data
Jul. 29, 2005 (JP) 2005-221791

(51) Int. Cl. B60T 8/44

(52) U.S. Cl. 303/114.3

(57) ABSTRACT

A master cylinder is connected to a vacuum booster which multiplies a brake operating force of a brake pedal. A push rod then transmits that multiplied force to an input piston and a pressurizing piston of the master cylinder. In addition, a hydraulic pump transmits a control pressure to the input piston and the pressurizing piston of the master cylinder such that a predetermined brake pressure is output from the master cylinder. A reaction force spring is also provided which applies a reaction force to the brake pedal which is greater than the reaction force transmitted from the vacuum booster to the operating rod.

### INCORPORATION BY REFERENCE

The disclosure of Japanese Patent Application No. 2005-221791 filed on Jul. 29, 2005, including the specification, drawings and abstract is incorporated herein by reference in its entirety.

### BACKGROUND OF THE INVENTION

1. Field of the Invention

The invention relates to a brake apparatus for a vehicle, which electronically controls a braking force applied to a vehicle with respect to a brake operating amount.

2. Description of the Related Art

An electronically controlled brake apparatus is known which electrically controls the braking force of a brake device, i.e., the hydraulic pressure supplied to a wheel cylinder that drives the brake device, with respect to a brake operating amount input from a brake pedal. One such brake apparatus is described in Japanese Patent Application Publication No. JP-A-2002-274360, for example.

In this hydraulic brake apparatus, a first piston defining a forward pressure chamber and a rear driving pressure chamber is housed inside a housing of a master cylinder. In addition, a second piston which is able to slide relative to the first piston is housed in the first piston. Forward of the second piston is communicated with the pressure chamber and rearward of the piston is communicated with the driving pressure chamber. This hydraulic brake apparatus can supply brake pressure to the driving pressure chamber according to an operation of the brake pedal. Accordingly, when the brake pedal is depressed such that brake pressure is supplied to the driving pressure chamber, the first and second pistons move forward together, forcing brake fluid from the pressure chamber. When the front end of the first piston abuts against the inside wall of the housing and the pressure in the driving pressure chamber is further increased, an expansion chamber expands and only the second piston moves forward. Accordingly, brake fluid inside the cylindrical body portion of the first piston is also delivered. As a result, the necessary amount of brake fluid to be delivered can be ensured while the overall length of the apparatus can be reduced.

In the foregoing hydraulic brake apparatus, when the driver depresses the brake pedal, an input member compresses a spring and moves a spool forward which opens all of the ports. As a result, brake hydraulic pressure is supplied to the driving pressure chamber which moves the first and second pistons forward thus forcing brake fluid from the pressure chamber. In this case, however, the pressures in the driving pressure chamber and the pressure chamber increase as the input member moves forward, such that a reaction force from this pressure change is transmitted to the brake pedal via the spool and the intake member, which adversely affects the way the brake pedal operation feels to the driver.

### SUMMARY OF THE INVENTION

In view of the foregoing problems, this invention thus provides a brake apparatus for a vehicle, which generates a braking force that is appropriate for the brake operating amount produced by a driver and improves the feel of a brake operation by preventing an undesirable brake operation reaction force from being transmitted to the driver.

A first aspect of the invention relates to a brake apparatus for a vehicle, which includes an operating member which is operated by a driver to brake the vehicle; an input member which transmits a pushing force according to the brake operation of the operating member; a vacuum booster which transmits a predetermined pressure in response to the pushing force of the input member; a master cylinder which outputs brake hydraulic pressure by an output piston moving due to the pressure transmitted from the vacuum booster; a hydraulic pressure supply device which moves the output piston by supplying hydraulic pressure to the master cylinder; and a reaction force apply device which applies a reaction force to the input member which is larger than the reaction force that is transmitted to the input member from the vacuum booster.

The hydraulic pressure supply device may supply to the master cylinder a predetermined hydraulic pressure which is set based on the brake hydraulic pressure from the master cylinder.

The hydraulic pressure supply device may supply to the master cylinder, based on an operating amount of the operating member, a predetermined hydraulic pressure which is set such that the output piston moves away from the input member.

The hydraulic pressure supply device may supply to the master cylinder a predetermined hydraulic pressure which is set based on the operating amount of the operating member, and if the operating amount exceeds a predetermined value which is set in advance, the hydraulic pressure supply device may supply to the master cylinder a predetermined pressure which is set such that the output piston moves away from the input member.

According to the foregoing structure, the brake apparatus for a vehicle includes a vacuum booster which transmits a predetermined pressure in response to the pushing force of the input member; a master cylinder which outputs brake hydraulic pressure by an output piston moving due to the pressure transmitted from the vacuum booster; a hydraulic pressure supply device which moves the output piston by supplying hydraulic pressure to the master cylinder; and a reaction force apply device which applies a reaction force to the input member which is larger than the reaction force that is transmitted to the input member from the vacuum booster. With this kind of structure, when pushing force according to a brake operation of the operating member is transmitted to the vacuum booster by the input member, the vacuum booster then transmits a predetermined pressure to the master cylinder, which moves the output piston so that brake hydraulic pressure is output. Also, when the hydraulic pressure supply device supplies hydraulic pressure to the master cylinder, some of the pressure to actuate the master cylinder is supplied by this hydraulic pressure supply device, which enables the output cylinder to be moved and brake hydraulic pressure to be output. Therefore, the maximum assist force applied to the master cylinder, which is determined by the sum of the vacuum pressure and the hydraulic pressure, can be stably increased to a high pressure. On the other hand, when the driver depresses the operating member, a constant reaction force is applied to that operating member by the reaction force apply device via the input member so a pressure change in the master cylinder is not transmitted to the operating member. As a result, an appropriate braking force according to the brake operating amount by the driver is able to be generated and an undesirable brake operation reaction force is prevented from being transmitted to the driver, thus improving the feel of the brake operation.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a block diagram schematically showing a brake apparatus for a vehicle according to a first example embodiment of the invention;

FIG. 2 is a flowchart illustrating braking force control of the brake apparatus for a vehicle according to the first example embodiment;

FIG. 3 is a graph showing the target control current value with respect to brake hydraulic pressure in the brake apparatus for a vehicle according to the first example embodiment;

FIG. 4 is a block diagram schematically showing a brake apparatus for a vehicle according to a second example embodiment of the invention;

FIG. 5 is a flowchart illustrating braking force control of the brake apparatus for a vehicle according to the second example embodiment;

FIG. 6 is a graph showing the output hydraulic pressure with respect to the pedal stroke in the brake apparatus for a vehicle according to the second example embodiment;

FIG. 7 is a block diagram schematically showing a brake apparatus for a vehicle according to a third example embodiment of the invention;

FIG. 8 is a flowchart illustrating braking force control of the brake apparatus for a vehicle according to the third example embodiment; and

FIG. 9 is a graph showing the output hydraulic pressure with respect to the pedal stroke in the brake apparatus for a vehicle according to the third example embodiment.

### DETAILED DESCRIPTION OF THE PREFERRED EMBODIMENTS

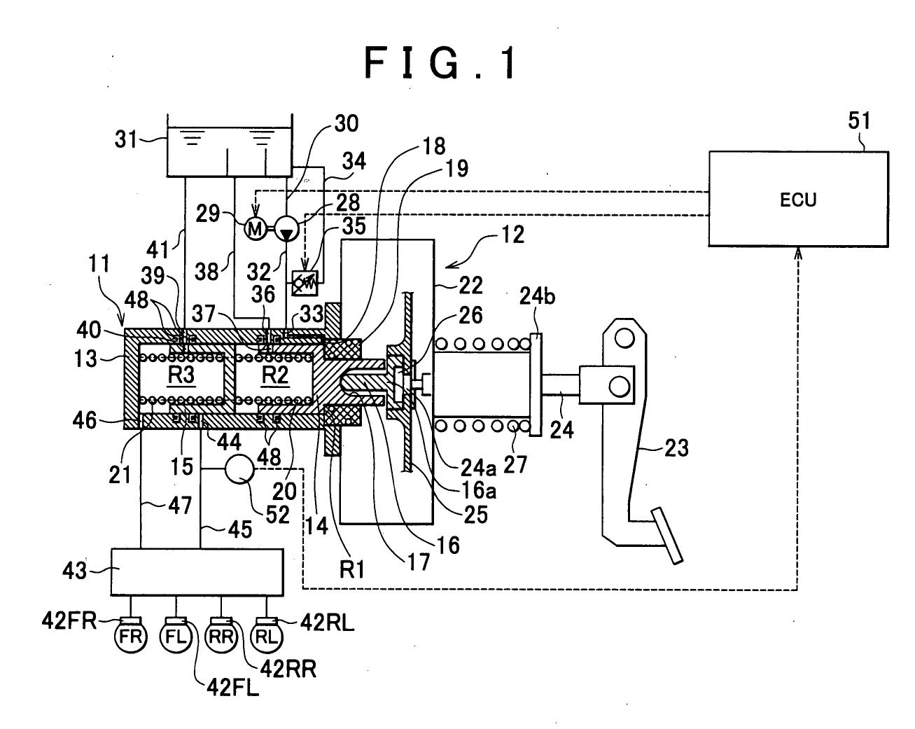

In a brake apparatus for a vehicle according to the first example embodiment, a master cylinder 11 and a vacuum booster 12 are integrally connected, as shown in FIG. 1. In this master cylinder 11, a cylinder 13 has a cylindrical shape with the base end portion open and the tip end portion closed. An input piston 14 and a pressurizing piston 15 are disposed on the same axis and supported so as to be able to slide in the axial direction inside the cylinder 13. The input piston 14, which is disposed toward the base end portion side of the cylinder 13, has a connecting portion 17 formed on its base end portion against which a tip end portion of a push rod 16 that serves as an input member abuts. Also, the input piston 14 has a cross-section that is shaped like the letter U with the tip end portion open. The outer peripheral surface of the input piston 14 is movably supported by the inner peripheral surface of the cylinder 13. A stepped portion 18 limits the movement of the stroke of the input piston 14 by abutting against a support member 19 that is fixed in place by being pressure-inserted or screwed into the inner peripheral surface of the cylinder 13.

Like the input piston 14, the pressurizing piston 15, which is disposed on the tip end side of the cylinder 13, also has a cross-section that is shaped like the letter U with the tip end portion open, and the outer peripheral surface of the pressurizing piston 15 is also movably supported by the inner peripheral surface of the cylinder 13. The movement of the stroke of the pressurizing piston 15 is limited by its front and rear end surfaces abutting against the cylinder 13 and the input piston 14. A first urging spring 20 disposed between the pressurizing piston 15 and the input piston 14 urges the input piston 14 into a position where it abuts against the support member 19. Also, a second urging spring 21 disposed between the cylinder 13 and the pressurizing piston 15 urges the pressurizing piston 15 into a position a predetermined distance away from the end surface, on the tip end portion side, of the cylinder 13. In this example embodiment, the input piston 14 and the pressurizing piston 15 together constitute an output piston.

Also, a housing 22 of the vacuum booster 12 is fixed to the base end portion of the cylinder 13. An operating rod 24 which is linked to a brake pedal 23 which serves as an operating member is connected to the housing 22. That is, a power piston 25 is movably supported in the housing 22. Both a tip end portion 24a of the operating rod 24 and a base end portion 16a of the push rod 16 are connected to this power piston 25. A space 26 is provided between the tip end portion 24a of the operating rod 24 and the base end portion 16a of the push rod 16.

A reaction spring 27 is provided between the housing 22 and a flange portion 24b of the operating rod 24. This reaction spring 27 serves as reaction force applying means for applying a reaction force that is greater than the reaction force transmitted from the vacuum booster 12 to the brake pedal 23 via the operating rod 24.

Accordingly, when a driver depresses the brake pedal 23 which pushes the operating rod 24, an air valve, not shown, opens allowing atmospheric air to rush into one of the chambers in the housing 22. As a result, the force pushing the power piston 25 by the operating rod 24 is multiplied. The push rod 16 can then push the input piston 14 with that multiplied pushing force.

By having the input piston 14 and the pressurizing piston 15 movably arranged in the axial direction inside the cylinder 13 in this way, three chambers are formed. That is, a first pressure chamber R1 is formed between the input piston 14 and the support member 19, a second pressure chamber R2 is formed between the input piston 14 and the pressurizing piston 15, and a third pressure chamber R3 is formed between the cylinder 13 and the pressurizing piston 15.

The hydraulic pump 28 which serves as hydraulic pressure supplying means is driven by a motor 29 to supply hydraulic pressure. The hydraulic pump 28 is connected both to a reservoir tank 31 via a line 30 and to a supply port 33 of the first pressure chamber R1 via a hydraulic pressure supply line 32. A linear valve 35 is provided in a hydraulic pressure discharge line 34 which is connected at one end to the hydraulic pressure supply line 32 and at the other end to the reservoir tank 31. This linear valve 35 is a flowrate regulating electromagnetic valve which is normally open.

Also, first and second discharge ports 36 and 37 which open to the second pressure chamber R2 are connected to the reservoir tank 31 via a first hydraulic pressure discharge line 38. Third and fourth discharge ports 39 and 40 which open to the third pressure chamber R3 are connected to the reservoir tank 31 via a second hydraulic pressure discharge line 41.

Meanwhile, wheel cylinders 42FR, 42FL, 42RR, and 42RL which actuate corresponding brake devices, not shown, are provided in the front wheels FR and FL and the rear wheels RR and RL, respectively. These wheel cylinders 42FR, 42FL, 42RR, and 42RL can be operated by an ABS (Antilock Brake System) 43. A first hydraulic pressure delivery line 45 is connected to a first delivery port 44 which opens to the second pressure chamber R2. This first hydraulic pressure delivery line 45 is connected to the ABS 43 and is able to supply hydraulic pressure to the wheel cylinders 42RR and 42RL of the rear wheels RR and RL. Similarly, a second hydraulic pressure delivery line 47 is connected to a second delivery port 46 formed in the third pressure chamber R3. This second hydraulic pressure delivery line 47 is also connected to the ABS 43 and is able to supply hydraulic pressure to the wheel cylinders 42FR and the 42FL of the front wheels FR and FL.

One-way seals 48 are installed between the cylinder 13 and the input piston 14, and the pressurizing piston 15, which prevent hydraulic pressure from leaking out in one direction.

In the brake apparatus for a vehicle according to this example embodiment having this kind of structure, an electronic control unit (ECU) 51 can reduce the necessary power multiplication required of the vacuum booster 12 by hydraulically assisting with the brake operation by supplying (with the hydraulic pressure supply device) to the master cylinder 11 a predetermined control hydraulic pressure which is set based on a brake hydraulic pressure from the master cylinder 11 detected by a pressure sensor 52. When this control hydraulic pressure is applied to the input piston 14, it generates brake hydraulic pressure. The ABS 43 then actuates the wheel cylinders 42FR, 42FL, 42RR, and 42RL such that braking force is applied to the front wheels FR and FL and the rear wheels RR and RL. In this example embodiment, the second and third pressure chambers R2 and R3 are pressurized, while balancing the pressures of the input piston 14 and the pressurizing piston 15, to generate brake hydraulic pressure by supplying control hydraulic pressure to the first pressure chamber R1.

Also in this example embodiment, a mechanism is provided which absorbs operating force input to the vacuum booster 12 from the brake pedal 23, thus preventing reaction force from the vacuum booster 12 from reaching the brake pedal 23. At the same time, a predetermined operating reaction force from the reaction spring 27 acts on the brake pedal 23.

That is, the pressure sensor 52 which detects hydraulic pressure is provided in the first hydraulic pressure delivery line 45. This pressure sensor 52 detects a brake hydraulic pressure Pr supplied to the wheel cylinders 42RR and 42RL of the rear wheels RR and RL from the second pressure chamber R2 through the first hydraulic pressure delivery line 45 and outputs the detection results to the ECU 51.

Accordingly, when the driver depresses the brake pedal 23, the vacuum booster 12 is activated such that the push rod 16 pushes the input piston 14. As a result, the input piston 14 pressurizes the second pressure chamber R2 while the pressurizing piston 15 pressurizes the third pressure chamber R3 such that brake hydraulic pressure is output from the delivery ports 44 and 46 to the hydraulic pressure delivery lines 45 and 47. When this brake hydraulic pressure is output, the pressure sensor 52 detects the brake hydraulic pressure Pr in the first hydraulic pressure delivery line 45 and the ECU 51 controls the hydraulic pump 28 and the linear valve 35 based on that detected brake hydraulic pressure Pr.

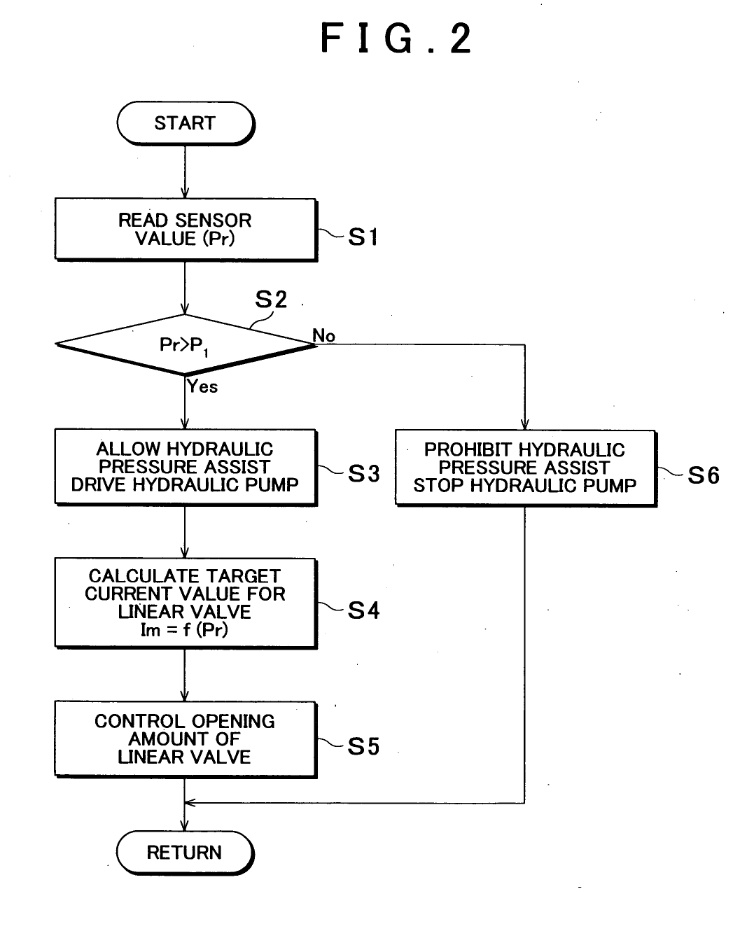

Braking force control of the brake apparatus for a vehicle according to this example embodiment will now be described with reference to the flowchart in FIG. 2. As shown in the drawing, in step S1 of the braking force control, the ECU 51 first obtains the brake hydraulic pressure Pr detected by the pressure sensor 52. Then in step S2, the ECU 51 determines whether to allow hydraulic pressure assist by determining whether the brake hydraulic pressure Pr detected by the pressure sensor 52 is larger than an initial brake hydraulic pressure P1 that was set in advance.

In this case, a target control current value Im is set so that a control current value Im of the linear valve 35 increases, i.e., the opening amount of the linear valve 35 which is normally open decreases, as the brake hydraulic pressure Pr rises from the point when the brake hydraulic pressure Pr becomes larger than the initial brake hydraulic pressure P1. In the region in which braking is slight from a brake hydraulic pressure Pr of 0 to the initial brake hydraulic pressure P1, hydraulic pressure assist is not allowed considering vibration and noise of the hydraulic pump 28. Also, in order to ensure that the push rod 16 and the input piston 14 are in constant contact with one another, the control hydraulic pressure supplied from the supply port 33 to the first pressure chamber R1 is set lower than the brake hydraulic pressure Pr that is delivered from the first delivery port 44.

When the driver depresses the brake pedal 23 such that the vacuum booster 12 activates and pushes the input piston 14, the input piston 14 and the pressurizing piston 15 move thus pressurizing the second and third pressure chambers R2 and R3. As a result, the brake hydraulic pressure Pr output from the first delivery port 44 to the first hydraulic pressure delivery line 45 rises. Therefore, when it is determined in step S2 that the brake hydraulic pressure Pr detected by the pressure sensor 52 is greater than the initial brake hydraulic pressure P1, hydraulic pressure assist is allowed and the hydraulic pump 28 is driven in step S3.

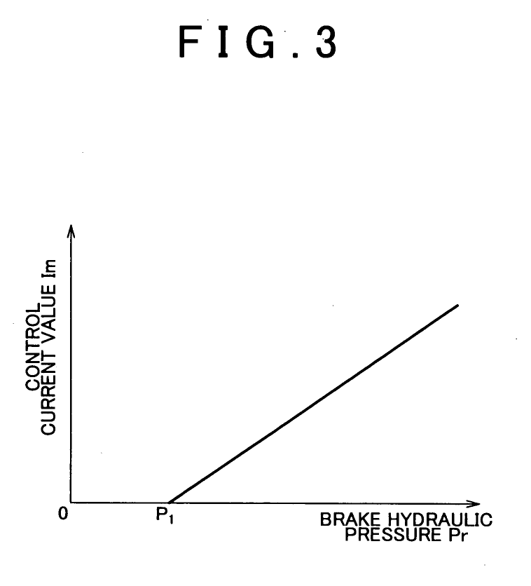

Continuing on, the target control current value Im to control the opening amount of the linear valve 35 is then set in step S4 based on the brake hydraulic pressure Pr using the map in FIG. 3. Then in step S5, the ECU 51 adjusts the opening amount of the linear valve 35 based on the target control current value Im that was set. When the opening amount of the linear valve 35 is adjusted, a predetermined control hydraulic pressure is supplied by the hydraulic pump 28 to the first pressure chamber R1 from the hydraulic pressure supply line 32 through the supply port 33. If, on the other hand it is determined that the brake hydraulic pressure Pr detected by the pressure sensor 52 is equal to or less than the initial brake hydraulic pressure P1, then hydraulic pressure assist is prohibited and the hydraulic pump 28 is stopped in step S6.

That is, when the driver first depresses the brake pedal 23, the vacuum booster 12 transmits the entire brake operating amount to the master cylinder 11 as pressure, and the master cylinder 11 then outputs a brake hydraulic pressure. When hydraulic pressure assist is allowed and control hydraulic pressure is supplied to the first pressure chamber R1 by the hydraulic pump 28, the hydraulic pump 28 transmits some or most of the brake operating amount to the master cylinder 11 as hydraulic pressure and the master cylinder 11 outputs brake hydraulic pressure, which reduces the workload of the vacuum booster 12. Then a predetermined brake hydraulic pressure Pr is applied from the second pressure chamber R2 to the first hydraulic pressure delivery line 45, while a predetermined brake hydraulic pressure Pf is applied from the third pressure chamber R3 to the second hydraulic pressure delivery line 47. These brake hydraulic pressures Pr and Pf are applied to the wheel cylinders 42FR, 42FL, 42RR, and 42RL via the ABS 43 such that a braking force according to the operating force of the brake pedal 23 exerted by the driver can be generated in the front wheels FR and FL and the rear wheels RR and RL.

When hydraulic pressure assist is allowed, even if the driver depresses the brake pedal 23, the tip end portion 24a of the operating rod 24 simply moves in the space 26 and does not push the push rod 16. As a result, there is no reaction force from the vacuum booster 12 against the operating force exerted by the driver. Instead, only a predetermined operating reaction force from the reaction spring 27 acts on the brake pedal 23. Thus, a suitable operating reaction force is transmitted to the driver without the change in pressure in the pressure chambers R1, R2, and R3 acting on the brake pedal 23.

When the driver depresses the brake pedal 23 and the vacuum booster 12 moves the input piston 14 and the pressurizing piston 15 of the master cylinder 11 a predetermined stroke movement, the first and second discharge ports 36 and 37 become offset such that hydraulic fluid stops being discharged from the second pressure chamber R2 to the reservoir tank 31, while the third and fourth discharge ports 39 and 40 also become offset such that hydraulic fluid stops being discharged from the third pressure chamber R3 to the reservoir tank 31. The second and third pressure chambers R2 and R3 can then be reliably pressurized when the hydraulic pump 28 supplies control hydraulic pressure to the first pressure chamber R1 and the input piston 14 and pressurizing piston 15 move. In this case, the brake hydraulic pressures Pr and Pf that are delivered are made substantially equal by balancing the hydraulic pressures of the second pressure chamber R2 and the third pressure chamber R3 according to the control hydraulic pressure applied to the first pressure chamber R1.

In this way, in the brake apparatus for a vehicle according to the first example embodiment, the master cylinder 11 is connected to the vacuum booster 12. The brake operating force of the brake pedal 23 is multiplied by the vacuum booster 12, and this multiplied brake operating force is then able to be transmitted to the input piston 14 and the pressurizing piston 15 of the master cylinder 11 via the push rod 16. In addition, hydraulic pressure assist is performed by using the hydraulic pump 28 to transmit a control pressure to the input piston 14 and the pressurizing piston 15 of the master cylinder 11 such that a predetermined brake hydraulic pressure is output from the master cylinder 11. Meanwhile, the reaction spring 27 is provided which applies a reaction force to the brake pedal 23 that is greater than the reaction force transmitted from the vacuum booster 12 to the operating rod 24.

Thus, when the driver depresses the brake pedal 23, the vacuum booster 12 transmits the entire brake operating amount to the master cylinder 11 as pressure, and the master cylinder then outputs the brake hydraulic pressure Pr. Then the ECU 51 controls the hydraulic pump 28 and the linear valve 35 based on the brake hydraulic pressure Pr detected by the pressure sensor 52 to supply a control hydraulic pressure to the first pressure chamber R1. As a result, control hydraulic pressure is supplied to the first pressure chamber R1 by the hydraulic pump 28, the hydraulic pump 28 transmits some or most of the brake operating amount to the master cylinder 11 as hydraulic pressure and the master cylinder 11 outputs brake hydraulic pressure That is, the load on the vacuum booster 12 can be reduced by using both the vacuum booster 12 and the hydraulic pump 28 to obtain the pressure applied to the master cylinder 11 in response to the brake operating amount. Consequently, the maximum assist force for the master cylinder which is determined by sum of the negative pressure of the vacuum booster 12 and the hydraulic pressure of the hydraulic pump 28 can be stably increased to a high pressure.

Meanwhile, when the driver depresses the brake pedal 23, a constant reaction force that is larger than the reaction force from the vacuum booster 12 is applied to the brake pedal 23 by the reaction spring 27. Therefore, the pressure change in the master cylinder 11 is not transmitted to the brake pedal 23 via the push rod 16 and the like. As a result, an appropriate braking force according to the brake operating amount by the driver can be generated. In addition, an undesirable brake operating reaction force is prevented from being transmitted to the driver, thus enabling the feel of the brake operation to be improved.

In the foregoing brake apparatus for a vehicle according to the first example embodiment, the linear valve 35 is arranged in the hydraulic pressure discharge line 34 which connects the supply port 33 to the reservoir tank 31. The control hydraulic pressure supplied by the hydraulic pump 28 to the first pressure chamber R1 via the hydraulic pressure supply line 32 through the supply port 33 is adjusted by adjusting the opening amount of this linear valve 35. The invention is not limited to this method, however. For example, the linear valve 35 may be a relief valve that opens when a predetermined pressure is exerted on it, and the control pressure supplied to the first pressure chamber R1 may be adjusted by adjusting the amount of hydraulic pressure delivered from the hydraulic pump 28.

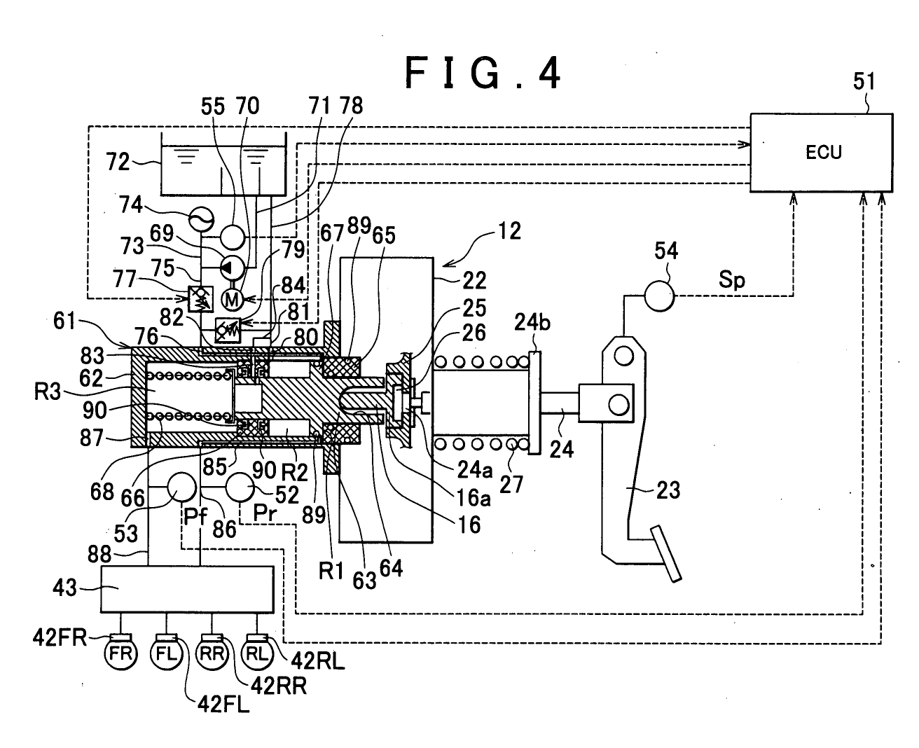

A second example embodiment of the invention will now be described with reference to FIGS. 4 to 6. Members in the second example embodiment which have the same function as members in the first example embodiment will be denoted by the same reference numerals, and redundant descriptions thereof will be omitted.

A brake apparatus for a vehicle according to the second example embodiment is structured such that a master cylinder 61 and a vacuum booster 12 are integrally connected, as shown in FIG. 4. The master cylinder 61 is structured such that a cylinder 62 has a cylindrical shape with a base end portion open and a tip end portion closed. An output piston 63 is supported so as to be able to move in the axial direction inside the cylinder 62. The output piston 63 has a connecting portion 64 formed on its base end portion against which a tip end portion of a push rod 16 abuts. The outer peripheral surface of the output piston 63 is movably supported by front and rear support members 65 and 66 that are fixed in place by being pressure-inserted or screwed into the inner peripheral surface of the cylinder 62. A disc-shaped flange portion 67 is movably supported by the inner peripheral surface of the cylinder 62. The movement stroke of the output piston 63 is restricted by the flange portion 67 abutting against the support members 65 and 66. An urging spring 68 disposed between the cylinder 62 and the output piston 63 urges the output piston 62 into a position where the flange portion 67 abuts against the support member 65.

Also, in the vacuum booster 12, a housing 22 is fixed to the base end portion of the cylinder 62, and the operating rod 24 which is connected to the brake pedal 23 is connected to the housing 22. That is, a power piston 25 is movably supported inside the housing 22, and both the tip end portion 24a of the operating rod 24 and the base end portion 16a of the push rod 16 are connected to this power piston 25. A space 26 is provided between the tip end portion 24a of the operating rod 24 and the base end portion 16a of the push rod 16.

Between the housing 22 and the flange portion 24b of the operating rod 24, a reaction spring 27 is provided which applies a reaction force to the brake pedal 23 that is greater than the reaction force transmitted to the brake pedal 23 from the vacuum booster 12 via the operating rod 24.

Accordingly, when a driver depresses the brake pedal 23 which pushes on the operating rod 24, an air valve, not shown, opens allowing atmospheric air to rush into one of the chambers in the housing 22. As a result, the force from the operating rod 24 pushing on the power piston is multiplied, and the push rod 16 pushes the output piston 63 with that multiplied pushing force.

By having the output piston 63 movably arranged inside the cylinder 62 in this way, three chambers are formed. That is, a first pressure chamber R1 is formed between the flange portion 67 and the support member 65, a second pressure chamber R2 is formed between the flange portion 67 and the support member 66, and a third pressure chamber R3 is formed between the cylinder 62 and the output piston 63.

A hydraulic pump 69 is driven by a motor 70 to supply hydraulic pressure. The hydraulic pump 69 is connected to both a reservoir tank 72 via a line 71 and an accumulator 74 via a line 73. The accumulator 74 is connected to a supply port 76 of the first pressure chamber R1 via a hydraulic pressure supply line 75 in which a first linear valve 77 is disposed. A second linear valve 79 is disposed in a hydraulic pressure discharge line 78 which is connected to the hydraulic pressure supply line 75 at one end and to the reservoir tank 72 at the other. The first linear valve 77 and the second linear valve 79 are both flowrate regulating electromagnetic valves. The first linear valve 77 is normally closed and the second linear valve 79 is normally open.

Further, a first discharge port 80 that is communicated with the second pressure chamber R2 is connected to the reservoir 72 via a first hydraulic pressure discharge line 81. Similarly, second and third discharge ports 82 and 83 which are communicated with the third pressure chamber R3 are connected to the reservoir tank 72 via a second hydraulic pressure discharge line 84.

Meanwhile, a first hydraulic pressure delivery line 86 is connected to a first delivery port 85 which is connected to the first pressure chamber R1. This first hydraulic pressure delivery line 86 is connected to ABS 43 and is able to supply hydraulic pressure to wheel cylinders 42RR and 42RL of rear wheels RR and RL. Similarly, a second hydraulic pressure delivery line 88 is connected to a second delivery port 87 formed in the third pressure chamber R3 and is able to supply hydraulic pressure to wheel cylinders 42FR and 42FL of front wheels FR and FR.

An O-ring 89 and a one-way seal 90 are installed between the cylinder 62 and the output piston 63 to prevent hydraulic pressure from leaking.

In the brake apparatus for a vehicle according to the example embodiment having this kind of structure, an electronic control unit (ECU) 51 sets a target control hydraulic pressure according to the operating amount (i.e., pedal stroke) of the brake pedal 23. A brake hydraulic pressure is then generated by applying this set target control hydraulic pressure to the output piston 63. The ABS 43 then actuates the wheel cylinders 42FR, 42FL, 42RR, and 42RL such that braking force is applied to the front wheels FR and FL and the rear wheels RR and RL.

Also in this example embodiment, operating force input from the brake pedal 23 to the vacuum booster 12 is absorbed, thus preventing reaction force from the vacuum booster 12 from reaching the brake pedal 23. At the same time, a predetermined operating reaction force from the reaction spring 27 acts on the brake pedal 23.

That is, a first pressure sensor 52 that detects hydraulic pressure is provided in the first hydraulic pressure delivery line 86 and a second pressure sensor 53 that also detects hydraulic pressure is provided in the second hydraulic pressure delivery line 88. The first pressure sensor 52 detects a brake hydraulic pressure Pr supplied through the first hydraulic pressure delivery line 86 from the first pressure chamber R1 to the wheel cylinders 42RR and 42RL of the rear wheels RR and RL and outputs the detection results to the ECU 51. Similarly, the second pressure sensor 52 detects a brake hydraulic pressure Pf supplied through the second hydraulic pressure delivery line 88 from the third pressure chamber R3 to the wheel cylinders 42FR and 42FL of the front wheels FR and FL and outputs the detection results to the ECU 51. Also, a stroke sensor 54 that detects a pedal stroke Sp of the brake pedal 23 is provided on the brake pedal 23. This stroke sensor 54 also outputs its detection results to the ECU 51. A third pressure sensor 55 that detects hydraulic pressure in the accumulator 74 is provided in the line 73. This third pressure sensor 55 outputs its detection results to the ECU 51 as well.

Accordingly, when the driver depresses the brake pedal 23, the ECU 51 sets a target control hydraulic pressure Pm based on the pedal stroke Sp detected by the stroke sensor 54. The ECU 51 then adjusts the opening amounts of the first and second linear valves 77 and 79, feeds back the brake hydraulic pressure Pr detected by the first pressure sensor 52, and performs control so that the brake hydraulic pressure Pr comes to match the target control hydraulic pressure Pm. In this case, the ECU 51 has a map of the target control hydraulic pressure Pm with respect to pedal stroke Sp, and controls the linear valves 77 and 79 based on this map.

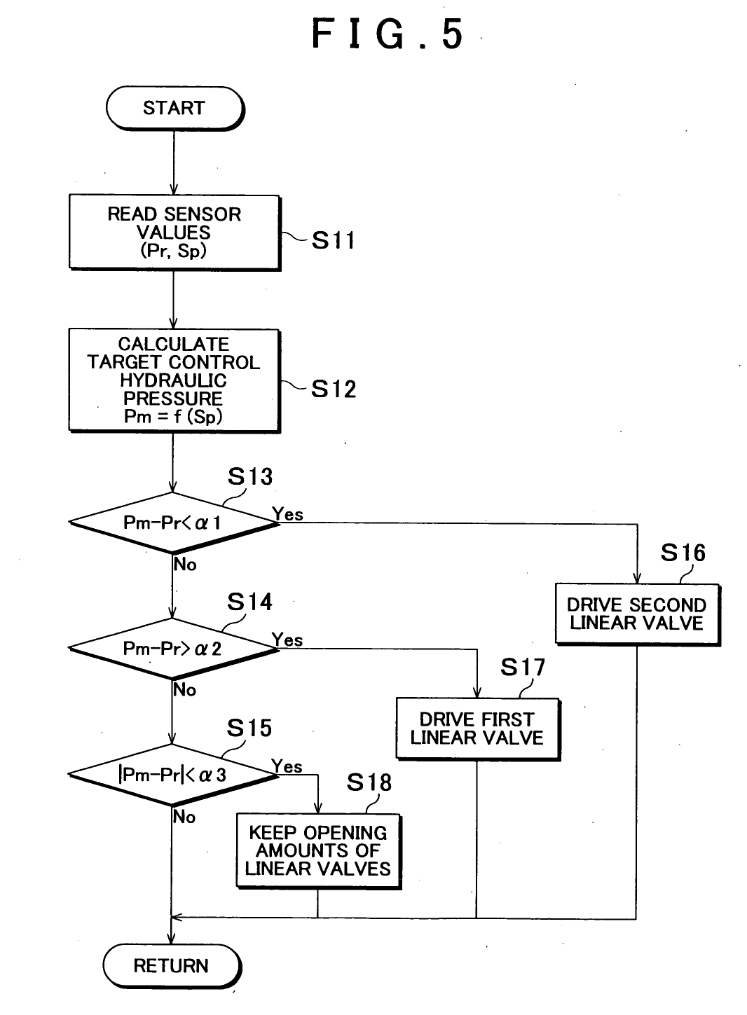

Braking force control of the brake apparatus for a vehicle according to this example embodiment will now be described based on the flowchart shown in FIG. 5. As shown in the drawing, in step S11 of the braking force control, the ECU 51 first obtains both the brake hydraulic pressure Pr detected by the first pressure sensor 52 and the pedal stroke Sp detected by the stroke sensor 54.

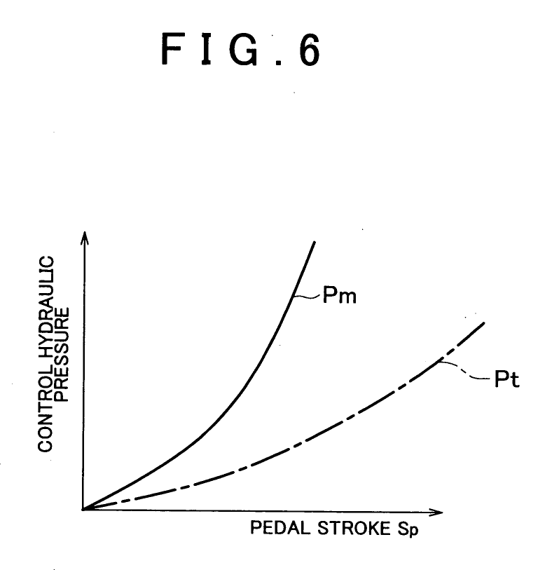

Then in step S12, the ECU 51 sets the target control hydraulic pressure Pm based on the pedal stroke Sp detected by the stroke sensor 54. In this case, as shown in FIG. 6, the target control hydraulic pressure Pm is set to increase, as the pedal stroke Sp increases, by a predetermined hydraulic pressure from an output hydraulic pressure Pt that corresponds to a brake hydraulic pressure able to be applied by the vacuum booster 12. That is, the target control hydraulic pressure Pm is set such that when the control hydraulic pressure is supplied from the supply port 76 to the first pressure chamber R1, the output piston 63 quickly moves away from the push rod 16.

Then when the driver depresses the brake pedal 23 further increasing the pedal stroke Sp, the target control hydraulic pressure Pm is supplied from the hydraulic pressure supply line 75 to the first pressure chamber R1 through the supply port 76. In step S13, it is determined whether the difference of the target control hydraulic pressure Pm minus the brake hydraulic pressure Pr is less than an upper limit value α1 that was set in advance, i.e., whether the actual brake hydraulic pressure Pr is too large with respect to the target control hydraulic pressure Pm. If it is determined here that the difference of the target control hydraulic pressure Pm minus the brake hydraulic pressure Pr is less than the upper limit value α1, i.e., if the brake hydraulic pressure Pr is too large with respect to the target control hydraulic pressure Pm, the process proceeds on to step S16 in which the second linear valve 79 is opened to reduce the control hydraulic pressure supplied to the first pressure chamber R1.

If, on the other hand, it is determined in step S13 that the difference of the target control hydraulic pressure Pm minus the brake hydraulic pressure Pr is not less than the upper limit value α1, it is then determined in step S14 whether the difference of the target control hydraulic pressure Pm minus the brake hydraulic pressure Pr is greater than a lower limit value α2, i.e., whether the actual brake hydraulic pressure Pr is too small with respect to the target control hydraulic pressure Pm. If it is determined here that the difference of the target control hydraulic pressure Pm minus the brake hydraulic pressure Pr is greater than the lower limit value α2, i.e., if the brake hydraulic pressure Pr is too small with respect to the target control hydraulic pressure Pm, the process proceeds on to step S17 in which the first linear valve 77 is opened to increase the control hydraulic pressure supplied to the first pressure chamber R1.

If it is determined in step S14 that the difference of the target control hydraulic pressure Pm minus the brake hydraulic pressure Pr is not greater than the lower limit value α2, it is then determined in step S15 whether the absolute value of the target control hydraulic pressure Pm minus the brake hydraulic pressure Pr is less than an appropriate value α3 which is set in advance, i.e., whether the actual brake hydraulic pressure Pr is within an appropriate range with respect to the target control hydraulic pressure Pm. If it is determined here that the absolute value of the target control hydraulic pressure Pm minus the brake hydraulic pressure Pr is less than the appropriate value α3, i.e., if the brake hydraulic pressure Pr is within an appropriate range with respect to the target control hydraulic pressure Pm, then the process proceeds on to step S18 in which the opening amounts of the linear valves 77 and 79 are maintained such that the control hydraulic pressure supplied to the first pressure chamber R1 is maintained. If, on the other hand, it is determined in step S15 that the absolute value of the target control hydraulic pressure Pm minus the brake hydraulic pressure Pr is not less than the appropriate value α3, then the routine directly ends without any control being performed.

Here, the upper limit value α1 is a value close to negative 0, the lower limit value α2 is a value close to positive 0, and the appropriate value α3 may be the same as the lower limit value α2.

That is, when the driver depresses the brake pedal 23, control hydraulic pressure set corresponding to the brake operating amount is supplied to the first pressure chamber R1 and the entire brake operating amount is transmitted to the master cylinder 61 as the control hydraulic pressure. As a result, the master cylinder outputs brake hydraulic pressure and the workload of the vacuum booster 12 is reduced to zero. Then, when a predetermined brake hydraulic pressure Pr is applied from the first pressure chamber R1 to the first hydraulic pressure delivery line 86 and a predetermined brake hydraulic pressure Pf is applied from the third pressure chamber R3 to the second hydraulic pressure delivery line 88, these brake hydraulic pressures Pr and Pf are applied to the wheel cylinders 42FR, 42FL, 42RR, and 42RL via the ABS 43, thus enabling a braking force according to the operating force of the brake pedal 23 exerted by the driver to be generated in the front wheels FR and FL and the rear wheels RR and RL.

Also, when the driver depresses the brake pedal 23 at this time, the tip end portion 24a of the operating rod 24 moves in the space 26 and so does not push the push rod 16. Therefore, there is no reaction force from the vacuum booster 12 against this operating force. Instead, a predetermined operating reaction force acts on the brake pedal 23 from the reaction spring 27. Thus, a suitable operating reaction force is transmitted to the driver without the change in pressure in the pressure chambers R1, R2, and R3 acting on the brake pedal 23.

When the driver depresses the brake pedal 23 and control hydraulic pressure is supplied to the first pressure chamber R1, the output piston 63 of the master cylinder 61 moves a predetermined stroke. As a result, the second and third discharge ports 82 and 83 become offset such that hydraulic fluid stops being discharged from the third pressure chamber R3 to the reservoir tank 72, thus enabling the first and third pressure chambers R1 and R3 to be reliably pressurized. In this case, the brake hydraulic pressures Pr and Pf that are delivered are made substantially equal by balancing the hydraulic pressures of the first pressure chamber R1 and the third pressure chamber R3 according to the control hydraulic pressure applied to the first pressure chamber R1.

In this way, in the brake apparatus for a vehicle according to the second example embodiment, the master cylinder 61 is connected to the vacuum booster 12, and the brake operating force of the brake pedal 23 is able to be transmitted to the input piston 63 of the master cylinder 61 by the push rod 16 via the vacuum booster 12. In addition, control pressure can be transmitted to the output piston 63 of the master cylinder 61 by the accumulator 74. A predetermined brake hydraulic pressure can then be output by setting the target control hydraulic pressure Pm based on the pedal stroke Sp and controlling the linear valves 77 and 79 based on that target control hydraulic pressure Pm so that a predetermined control hydraulic pressure is supplied to the master cylinder 61. Meanwhile, the reaction spring 27 is provided which applies a reaction force to the brake pedal which is greater than the reaction force transmitted from the vacuum booster 12 to the operating rod 24.

Accordingly, when the driver depresses the brake pedal 23, the opening amounts of the linear valves 77 and 79 are controlled based on that pedal stroke Sp such that a predetermined control hydraulic pressure is supplied to the master cylinder 61. The entire brake operating amount is transmitted to the master cylinder 61 as control hydraulic pressure. The master cylinder 61 then outputs a brake hydraulic pressure Pr corresponding to this control hydraulic pressure. That is, by obtaining the pressure applied to the master cylinder 61 according to the brake operating amount using only the hydraulic pump 69, the output of the vacuum booster 12 can be reduced to 0, thus enabling the vacuum consumption to be reduced. Also, the control hydraulic pressure supplied to the master cylinder 61 can be controlled regardless of the operating amount that the driver exerts on the brake pedal 23 so a bi-wire mechanism can easily be established.

Meanwhile, when the driver depresses the brake pedal 23, a constant reaction force that is greater than the reaction force produced by the vacuum booster 12 is applied by the reaction spring 27 to the brake pedal 23, so the pressure change in the master cylinder 61 is not transmitted to the brake pedal 23 via the push rod 16 and the like. As a result, an appropriate braking force according to the brake operating amount by the driver can be generated. In addition, an undesirable brake operating reaction force is prevented from being transmitted to the driver, thereby enabling the feel of the brake operation to be improved.

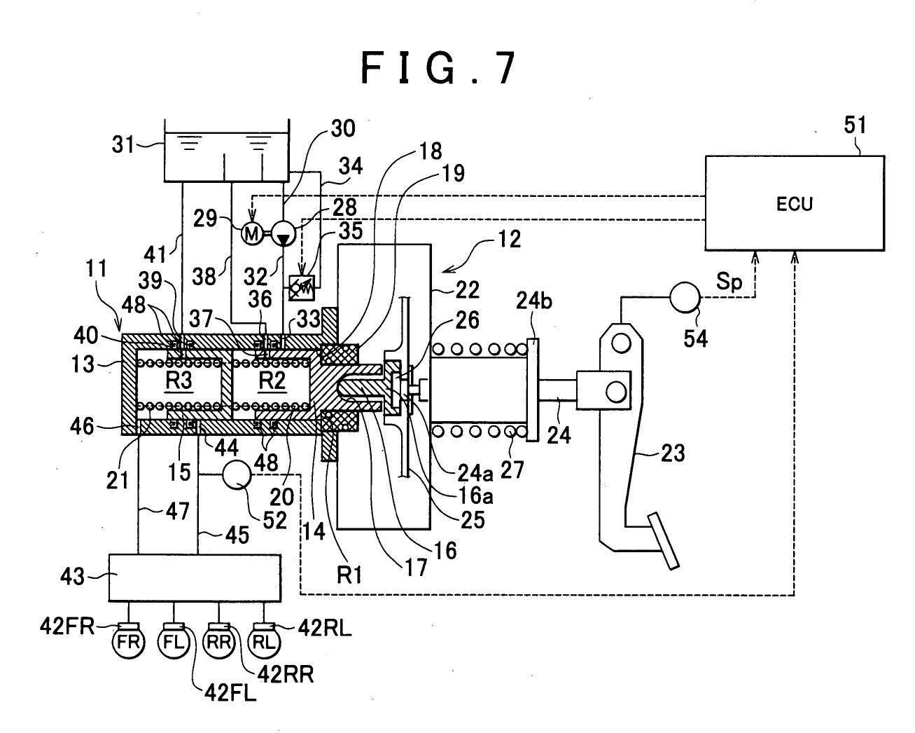

A third example embodiment will now be described with reference to FIGS. 7 to 9. Members in the third example embodiment which have the same function as members in the foregoing example embodiments will be denoted by the same reference numerals, and redundant descriptions thereof will be omitted.

A brake apparatus for a vehicle according to the third example embodiment is structured such that a master cylinder 11 and a vacuum booster 12 are integrally connected, as shown in FIG. 7. The master cylinder 11 is structured such that an input piston 14 and a pressurizing piston 15 are disposed on the same axis and supported so as to be able to slide in the axial direction inside a cylinder 13. A first urging spring 20 urges the input piston 14 into a position where it abuts against the support member 19. Similarly, a second urging spring 21 urges the pressurizing piston 15 into a position a predetermined distance away from the end surface, on the tip end portion side, of the cylinder 13.

In the vacuum booster 12, a power piston 25 is movably supported in a housing 22. Both a tip end portion 24a of an operating rod 24 of the brake pedal 23 and a base end portion 16a of the push rod 16 are connected to this power piston 25. A space 26 is provided between the tip end portion 24a of the operating rod 24 and the base end portion 16a of the push rod 16. A reaction spring 27 is provided between the housing 22 and a flange 24b of the operating rod 24. This reaction spring 27 applies a reaction force to the brake pedal 23 which is greater than the reaction force transmitted from the vacuum booster 12 to the brake pedal 23 via the operating rod 24.

By having the input piston 14 and the pressurizing piston 15 movably arranged in the axial direction inside the cylinder 13 in this way, three chambers are formed. That is, a first pressure chamber R1 is formed between the input piston 14 and a support member 19, a second pressure chamber R2 is formed between the input piston 14 and the pressurizing piston 15, and a third pressure chamber R3 is formed between the cylinder 13 and the pressurizing piston 15.

The hydraulic pump 28 which is driven by a motor 29 is connected to a reservoir tank 31 via a line 30, as well as to a supply port 33 of the first pressure chamber R1 via a hydraulic pressure supply line 32. A normally open linear valve 35 is disposed in a hydraulic pressure discharge line 34 which is connected to the hydraulic pressure supply line 32 at one end and to the reservoir tank 31 at the other end. Also, first and second discharge ports 36 and 37 which are connected to the second pressure chamber R2 are connected to the reservoir tank 31 via a first hydraulic pressure discharge line 38. Similarly, third and fourth discharge ports 39 and 40 which are communicated with the third pressure chamber R3 are connected to the reservoir tank 31 via a second hydraulic pressure discharge line 41.

In addition, a first hydraulic pressure delivery line 45 is connected to a first delivery port 44 which is connected to the second pressure chamber R2. This first hydraulic pressure delivery line 45 is connected to ABS 43 and is able to supply hydraulic pressure to wheel cylinders 42RR and 42RL of rear wheels RR and RL. Similarly, a second hydraulic pressure delivery line 47 is connected to a second delivery port 46 formed in the third pressure chamber R3. This second hydraulic pressure delivery line 47 is also connected to the ABS 43 and is able to supply hydraulic pressure to wheel cylinders 42FR and the 42FL of front wheels FR and FL.

In the brake apparatus for a vehicle according to this example embodiment having this kind of structure, when the operating amount (i.e., pedal stroke) of the brake pedal 23 exceeds a predetermined value, an electronic control unit (ECU) 51 sets a target control hydraulic pressure according to that operating amount. The ECU 51 then generates brake hydraulic pressure by applying that set target control hydraulic pressure to the input piston 14, and actuates the wheel cylinders 42FR, 42FL, 42RR, and 42RL using the ABS 43 to apply braking force to the front wheels FR and FL and the rear wheels RR and RL. In this case, in this example embodiment, the second and third pressure chambers R2 and R3 are pressurized, while balancing the pressures of the input piston 14 and the pressurizing piston 15, to generate brake hydraulic pressure by supplying control hydraulic pressure to the first pressure chamber R1.

Also in this example embodiment, operating force input from the brake pedal 23 to the vacuum booster 12 is absorbed, thus preventing reaction force from the vacuum booster 12 from reaching the brake pedal 23. At the same time, a predetermined operating reaction force from the reaction spring 27 acts on the brake pedal 23.

That is, a pressure sensor 52 that detects hydraulic pressure is provided in the first hydraulic pressure delivery line 45. This pressure sensor 52 detects a brake hydraulic pressure Pr supplied through the first hydraulic pressure delivery line 45 from the first pressure chamber R1 to the wheel cylinders 42RR and 42RL of the rear wheels RR and RL and outputs the detection results to the ECU 51. Also, a stroke sensor 54 that detects a pedal stroke Sp of the brake pedal 23 is provided on the brake pedal 23. This stroke sensor 54 also outputs its detection results to the ECU 51.

Accordingly, when the driver depresses the brake pedal 23 and the pedal stroke Sp detected by the stroke sensor 54 is greater than a predetermined stroke S1, the ECU 51 sets a target control hydraulic pressure Pm based on this pedal stroke Sp and adjusts the opening amount of the linear valve 35. The ECU 51 then feeds back the brake hydraulic pressure Pr detected by the pressure sensor 52, and performs control so that the brake hydraulic pressure Pr comes to match the target control hydraulic pressure Pm. The ECU 51 has a map of target control hydraulic pressure Pm with respect to pedal stroke Sp, and controls the linear valve 35 based on this map.

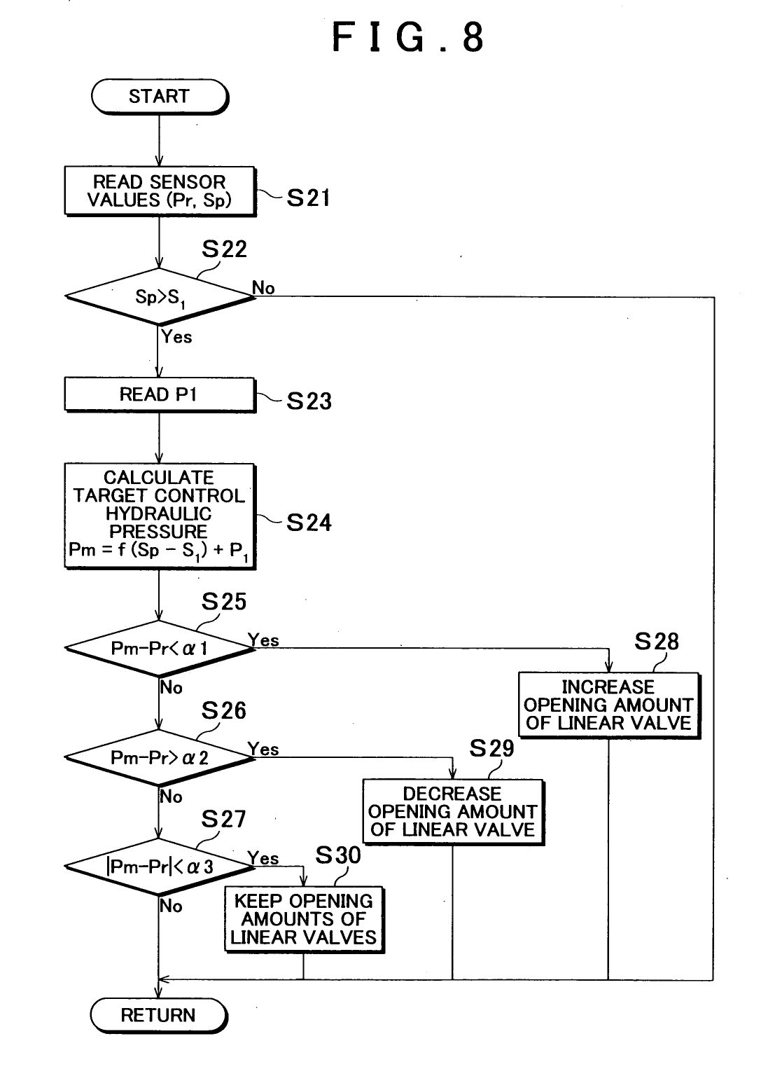

Braking force control of the brake apparatus for a vehicle according to this example embodiment will now be described based on the flowchart shown in FIG. 8. As shown in the drawing, in step S21 of the braking force control, the ECU 51 first obtains both the brake hydraulic pressure Pr detected by the pressure sensor 52 and the pedal stroke Sp detected by the stroke sensor 54. Then in step S22, it is determined whether the pedal stroke Sp detected by the stroke sensor 54 is greater than an initial stroke S1 that was set in advance.

If it is determined in step S22 that the pedal stroke Sp is equal to or less than the initial stroke S1, the routine directly ends without any control being performed. That is, if the pedal stroke Sp is equal to or less than the initial stroke S1 when the driver depresses the brake pedal 23, no control hydraulic pressure is supplied to the supply port 33; only the vacuum booster 12 is actuated to push the input piston 14. The input piston 14 and the pressurizing piston 15 move so the second and third pressure chambers R2 and R3 pressurize such that the predetermined brake hydraulic pressures Pr and Pf are output from the first and second delivery ports 44 and 46 to the first and second hydraulic pressure delivery lines 45 and 47.

If, on the other hand, it is determined in step S22 that the pedal stroke Sp is greater than the initial stroke S1, then the ECU 51 reads a brake hydraulic pressure Pr of P1 corresponding to when the pedal stroke Sp is S1 from a map in step S23.

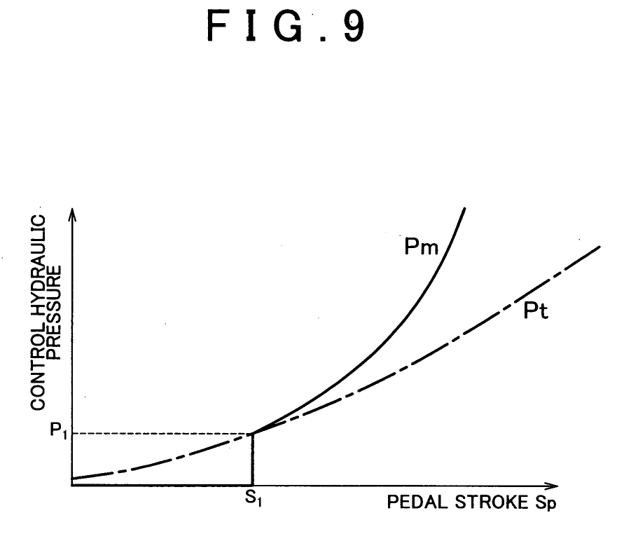

Then in step S24, the ECU 51 sets a target control hydraulic pressure Pm based on the pedal stroke Sp detected by the stroke sensor 54 and a brake hydraulic pressure Pr of P1 which corresponds to a pedal stroke Sp of S1. In this case, as shown in FIG. 9, when the pedal stroke Sp is equal to or less than the initial stroke S1, the vacuum booster 12 generates the brake hydraulic pressure so the target control hydraulic pressure Pm is 0. When the pedal stroke Sp is greater than the initial stroke S1, the target control hydraulic pressure Pm is set to increase by a predetermined hydraulic pressure from the output hydraulic pressure Pt that corresponds to a brake hydraulic pressure that is able to be applied by the vacuum booster 12. Therefore, the target control hydraulic pressure Pm is set so that when the control hydraulic pressure is supplied from the supply port supply port 33 to the first pressure chamber R1, the input piston 14 which is contacting the push rod 16 quickly moves away from the push rod 16.

Then when the driver depresses the brake pedal 23 further increasing the pedal stroke Sp, the target control hydraulic pressure Pm is supplied from the hydraulic pressure supply line 32 to the first pressure chamber R1 through the supply port 33. In step S25, it is determined whether the difference of the target control hydraulic pressure Pm minus the brake hydraulic pressure Pr is less than an upper limit value α1 that was set in advance, i.e., whether the actual brake hydraulic pressure Pr is too large with respect to the target control hydraulic pressure Pm. If it is determined here that the difference of the target control hydraulic pressure Pm minus the brake hydraulic pressure Pr is less than the upper limit value α1, i.e., that the actual brake hydraulic pressure Pr is too large with respect to the target control hydraulic pressure Pm, then the process proceeds on to step S28 in which the linear valve 35 is opened to reduce the control hydraulic pressure supplied to the first pressure chamber R1.

If, on the other hand, it is determined in step S25 that the difference of the target control hydraulic pressure Pm minus the brake hydraulic pressure Pr is not less than the upper limit value α1, then it is determined in step S26 whether the difference of the target control hydraulic pressure Pm minus the brake hydraulic pressure Pr is greater than a lower limit value α2 that was set in advance, i.e., whether the actual brake hydraulic pressure Pr is too small with respect to the target control hydraulic pressure Pm. If it is determined here that the difference of the target control hydraulic pressure Pm minus the brake hydraulic pressure Pr is greater than the lower limit value α2, i.e., that the actual brake hydraulic pressure Pr is too small with respect to the target control hydraulic pressure Pm, then the process proceeds on to step S29 in which the linear valve 35 is closed to increase the control hydraulic pressure supplied to the first pressure chamber R1.

If it is determined in step S26 that the difference of the target control hydraulic pressure Pm minus the brake hydraulic pressure Pr is not greater than the lower limit value α2, then it is determined in step S27 whether the absolute value of the target control hydraulic pressure Pm minus the brake hydraulic pressure Pr is less than an appropriate value α3 that was set in advance, i.e., whether the actual brake hydraulic pressure Pr is within an appropriate range with respect to the target control hydraulic pressure Pm. If it is determined here that the absolute value of the target control hydraulic pressure Pm minus the brake hydraulic pressure Pr is less than the appropriate value α3, i.e., if the brake hydraulic pressure Pr is within the appropriate range with respect to the target control hydraulic pressure Pm, then the process proceeds on to step S30 in which the opening amount of the linear valve 35 is maintained such that the control hydraulic pressure supplied to the first pressure chamber R1 is maintained. If, on the other hand, it is determined in step S27 that the absolute value of the target control hydraulic pressure Pm minus the brake hydraulic pressure Pr is not less than the appropriate value α3, then the routine directly ends without any control being performed.

Here, the upper limit value α1 is a value close to negative 0, the lower limit value α2 is a value close to positive 0, and the appropriate value α3 may be the same as the lower limit value α2.

That is, during the initial period in which the driver just slightly depresses the brake pedal 23, the vacuum booster 12 transmits the entire brake operating amount to the master cylinder 11 as pressure and the master cylinder 11 outputs a brake hydraulic pressure. Then when the driver depresses the brake pedal 23 beyond a predetermined stroke, a control hydraulic pressure set according to the brake operating amount is supplied to the first pressure chamber R1 and the entire brake operating amount is transmitted to the master cylinder 11 as the control hydraulic pressure. As a result, the master cylinder 11 outputs brake hydraulic pressure and the workload of the vacuum booster 12 is reduced to zero. Then, when a predetermined brake hydraulic pressure Pr is applied from the second pressure chamber R2 to the first hydraulic pressure delivery line 45 and a predetermined brake hydraulic pressure Pf is applied from the third pressure chamber R3 to the second hydraulic pressure delivery line 47, these brake hydraulic pressures Pr and Pf are applied to the wheel cylinders 42FR, 42FL, 42RR, and 42RL via the ABS 43, thus enabling a braking force according to the operating force on the brake pedal 23 exerted by the driver to be generated in the front wheels FR and FL and the rear wheels RR and RL.

Also, when the driver depresses the brake pedal 23 beyond the predetermined stroke, the tip end portion 24a of the operating rod 24 moves in the space 26 and so does not push the push rod 16. Therefore, there is no reaction force from the vacuum booster 12 against this operating force. Instead, a predetermined operating reaction force acts on the brake pedal 23 from the reaction spring 27. Thus, a suitable operating reaction force is transmitted to the driver without the change in pressure in the pressure chambers R1, R2, and R3 acting on the brake pedal 23.

When the driver depresses the brake pedal 23 and the vacuum booster 12 moves the input piston 14 and the pressurizing piston 15 of the master cylinder 11 a predetermined stroke, the first and second discharge ports 36 and 37 become offset such that hydraulic fluid stops being discharged from the second pressure chamber R2 to the reservoir tank 31. At the same time, the third and fourth discharge ports 39 and 40 also become offset such that hydraulic fluid stops being discharged from the third pressure chamber R3 to the reservoir tank 31. The second and third pressure chambers R2 and R3 can then be reliably pressurized when the hydraulic pump 28 supplies control hydraulic pressure to the first pressure chamber R1 and the input piston 14 and pressurizing piston 15 move. In this case, the brake hydraulic pressures Pr and Pf that are delivered are made substantially equal by balancing the hydraulic pressures of the second pressure chamber R2 and the third pressure chamber R3 according to the control hydraulic pressure applied to the first pressure chamber R1.

In this way, in the brake apparatus for a vehicle according to the third example embodiment, the master cylinder 11 is connected to the vacuum booster 12. When the pedal stroke is equal to or less than a predetermined pedal stroke, the brake operating force of the brake pedal 23 is multiplied by the vacuum booster 12, and this multiplied brake operating force can be transmitted to the input piston 14 and the pressurizing piston 15 of the master cylinder 11 via the push rod 16. On the other hand, when the pedal stroke is greater than the predetermined pedal stroke, the hydraulic pump 28 can transmit control pressure to the input piston 14 and the pressurizing piston 15 of the master cylinder 11 so that a predetermined control hydraulic pressure can be output from the master cylinder 11. Also, the reaction spring 27 is provided which applies a reaction force to the brake pedal 23 that is greater than the reaction force transmitted from the vacuum booster 12 to the operating rod 24.

Accordingly, when the driver depresses the brake pedal 23, and the pedal stroke is equal to or less than the predetermined pedal stroke, the vacuum booster 12 transmits the entire brake operating amount to the master cylinder 11 as pressure and the master cylinder 11 outputs the brake hydraulic pressure Pr. When the pedal stroke is greater than the predetermined pedal stroke, the ECU 51 controls the opening amount of the linear valve 35 based on the pedal stroke Sp to supply a predetermined control hydraulic pressure to the master cylinder 11 such that the entire brake operating amount is transmitted to the master cylinder 11 as control pressure, and the master cylinder 11 then outputs the brake hydraulic pressure Pr. That is, when the brake operating amount is small, the pressure that is applied to the master cylinder 11 is provided using the vacuum booster 12. When the brake operating amount becomes larger, however, the pressure that is applied to the master cylinder is provided using only the hydraulic pump 28. As a result, the load on the vacuum booster 12 can be reduced. In addition, brake hydraulic pressure can be generated midway through a brake operation using only hydraulic pressure without using the vacuum booster 12, which enables the braking characteristics to be set freely.

On the other hand, when the driver depresses the brake pedal 23, a constant reaction force which is larger than the reaction force generated by the vacuum booster 12 is applied to the brake pedal 23 by the reaction spring 27. Therefore, the pressure change in the master cylinder 11 is not transmitted to the brake pedal 23 via the push rod 16 and the like. As a result, a braking force can be generated which is suitable for the brake operating amount by the driver. Moreover, an undesirable brake operation reaction force is prevented from being transmitted to the driver so the feel of the brake operation is improved.

In the foregoing brake apparatus for a vehicle according to the third example embodiment, if it is determined in step S22 that the pedal stroke Sp is larger than the initial stroke S1, the target control hydraulic pressure Pm is set in step S24 referencing a map based on the pedal stroke Sp and the linear valve 35 is driven according to this target control hydraulic pressure Pm. The invention is not limited to this method, however. For example, if it is determined that the pedal stroke speed is greater than the initial stroke speed, a brake hydraulic pressure Pr of Pt at this time may be obtained, the target control hydraulic pressure Pm may be set based on the pedal stroke Sp and the brake hydraulic pressure Pt, and the linear valve 35 may be driven according to this target control hydraulic pressure Pm.

In the vacuum booster 12 in the foregoing example embodiments, both the tip end portion 24a of the operating rod 24 of the brake pedal 23 and the base end portion 16a of the push rod 16 are connected to the power piston 25, and the space 26 is provided between the tip end portion 24a of the operating rod 24 and the base end portion 16a of the push rod 16. Alternatively, however, a reaction disc that generates a smaller reaction force than the reaction spring 27 may be provided.

As described above, the brake apparatus for a vehicle according to the invention ensures that pressure according to the brake operating amount is applied to the master cylinder using a vacuum booster and hydraulic pressure supply device, and is suitable for use in any type of brake system.

While the invention has been described with reference to exemplary embodiments thereof, it is to be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

What is claimed is:

1. A brake apparatus for a vehicle, comprising:
an operating member which is operated by a driver to brake the vehicle;
an input member which transmits a pushing force according to the brake operation of the operating member;
a vacuum booster which transmits a predetermined pressure in response to the pushing force of the input member;
a master cylinder which outputs brake hydraulic pressure by an output piston moving due to the pressure transmitted from the vacuum booster;
a hydraulic pressure supply device which moves the output piston by supplying hydraulic pressure to the master cylinder; and
a reaction force apply device which applies to the input member a reaction force which is larger than the reaction force that is transmitted to the input member from the vacuum booster.

2. The brake apparatus for a vehicle according to claim 1, wherein the hydraulic pressure supplying device supplies to the master cylinder a predetermined hydraulic pressure which is set based on the brake hydraulic pressure from the master cylinder.

3. The brake apparatus for a vehicle according to claim 1, wherein the hydraulic pressure supplying device supplies to the master cylinder, based on an operating amount of the operating member, a predetermined hydraulic pressure which is set such that the output piston moves away from the input member.

4. The brake apparatus for a vehicle according to claim 1, wherein the hydraulic pressure supplying device supplies to the master cylinder a predetermined hydraulic pressure which is set based on the operating amount of the operating member, and if the operating amount exceeds a predetermined value which is set in advance, the hydraulic pressure supplying device supplies to the master cylinder a predetermined pressure which is set such that the output piston moves away from the input member.
